(19) United States
(12) Patent Application Publication
(10) Pub. No.: US 2014/0307184 A1
(43) Pub. Date: Oct. 16, 2014

(54) TOUCH PANEL

(71) Applicant: WINTEK CORPORATION, Taichung City (TW)

(72) Inventors: Chi-Ming Hsieh, Taichung City (TW); Yi-Chen Tsai, Taichung City (TW); Kuo-Chuan Tseng, Changhua County (TW)

(73) Assignee: WINTEK CORPORATION, Taichung City (TW)

(21) Appl. No.: 14/249,367

(22) Filed: Apr. 10, 2014

(30) Foreign Application Priority Data
Apr. 11, 2013 (TW) 102112922

(51) Int. Cl. G06F 3/044

(52) U.S. Cl. CPC G06F 3/044
USPC 349/12

(57) ABSTRACT

A touch panel includes a substrate and a crossed sensing unit. The crossed sensing unit is disposed on the substrate, and the crossed sensing unit includes a first electrode, a second electrode, and a connecting line. The first electrode includes two sub electrodes disposed separately from each other and aligned along a first direction. The second electrode is disposed between the two sub electrodes. The connecting line is electrically connecting the two sub electrodes, and the connecting line does not overlap the second electrode along a vertical projective direction perpendicular to the substrate.

### BACKGROUND OF THE INVENTION

1. Field of the Invention

The present invention generally relates to a touch panel, and more particularly, to a touch panel including a crossed sensing unit without bridge connection designs.

2. Description of the Prior Art

In recent years, touch sensing technologies have developed flourishingly. There are many diverse technologies of touch panel, such as the resistance touch technology, the capacitive touch technology and the optical touch technology which are the main touch technologies in use. The capacitive touch technology has become the mainstream touch technology for the high-end and the mid-end consumer electronics, because the capacitive touch panel has advantages such as high precision, multi-touch property, better endurance, and higher touch resolution. In the capacitive touch technology, sensing electrodes are used to detect the variations of electrical capacitances around a touch point, and feedback signals are transmitted via connecting lines, which interconnect all of the sensing electrodes along different axis directions to locate the touch points.

Please refer to FIGS. 1-5. FIG. 1 is a schematic diagram illustrating a traditional crossed sensing unit of a touch panel. FIG. 2 is a schematic cross-sectional diagram taken along a line A-A′ in FIG. 1. FIG. 3 is a schematic diagram illustrating a condition that a position of a light-shielding layer in FIG. 2 is shifted. FIG. 4 is a schematic diagram illustrating another traditional crossed sensing unit of a touch panel. FIG. 5 is a schematic cross-sectional diagram taken along a line B-B′ in FIG. 4. As shown in FIG. 1 and FIG. 2, a traditional crossed sensing unit 10 of a touch panel includes a first transparent electrode 51, a second transparent electrode 52 and a metal bridge connection line 30 disposed on a substrate 11. The second transparent electrode 52 crosses the first transparent electrode 51, and the metal bridge connection line 30 overlaps the first transparent electrode 51 and the second transparent electrode 52 along a vertical projective direction Z perpendicular to the substrate 11. The first transparent electrode 51 includes two transparent sub electrodes 51S disposed separately from each other and aligned along a first direction X. The second transparent electrode 52 is disposed between the two transparent sub electrodes 51S along the first direction X. The metal bridge connection line 30 is used to electrically connect the two transparent sub electrodes 51. In the traditional touch panel, a light-shielding layer 20 disposed on the substrate 11 has an opening hole 20H configured to form a virtual key pattern 21. The crossed sensing unit 10 is disposed correspondingly to the virtual key pattern 21. When the metal bridge connection line 30 is disposed on the light-shielding layer 20 (as shown in FIG. 2), the second transparent electrode 52 may crack during the manufacturing process because of the terrain like a valley formed by the light-shielding layer 20 and the metal bridge connection line 30, and the related manufacturing yield will be influenced. This issue will be more serious when an insulation block 40 has to be disposed between the metal bridge connection line 30 and the second transparent electrode 52 for electrically insulating the metal bridge connection line 30 from the second transparent electrode 52. In addition, as shown in FIG. 3, when a position of the light-shielding layer 20 on the substrate 11 is shifted because of the process variations, the second transparent electrode 52 will tend to crack more likely under this structure, and the metal bridge connection line 30 will tend to crack also. Additionally, as shown in FIG. 4 and FIG. 5, in another traditional crossed sensing unit 10′ of a touch panel, the metal bridge connection line 30 is disposed correspondingly to the opening hole 20H, and the second transparent electrode 52 still may crack during the manufacturing process because of the terrain like a valley formed by the metal bridge connection line 30 in the opening hole 20H, and the related manufacturing yield will still be influenced. In addition, the metal bridge connection line 30 may cause problems such as electrostatic damages and stray capacitances. The manufacturing yield and the touch operation will be influenced by the metal bridge connection line 30 accordingly.

### SUMMARY OF THE INVENTION

It is one of the objectives of the present invention to provide a touch panel. Two separated sub electrodes in a crossed sensing unit are electrically connected by a non-bridge connection approach so as to improve manufacturing yield, product reliability and touch sensing effects.

To achieve the purposes described above, a preferred embodiment of the present invention provides a touch panel. The touch panel includes a substrate and a crossed sensing unit. The crossed sensing unit is disposed on the substrate, and the crossed sensing unit includes a first electrode, a second electrode, and a connecting line. The first electrode includes two sub electrodes disposed separately from each other and aligned along a first direction. The second electrode is disposed between the two sub electrodes. The connecting line is electrically connecting the two sub electrodes, and the connecting line does not overlap the second electrode along a vertical projective direction perpendicular to the substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a traditional crossed sensing unit of a touch panel.

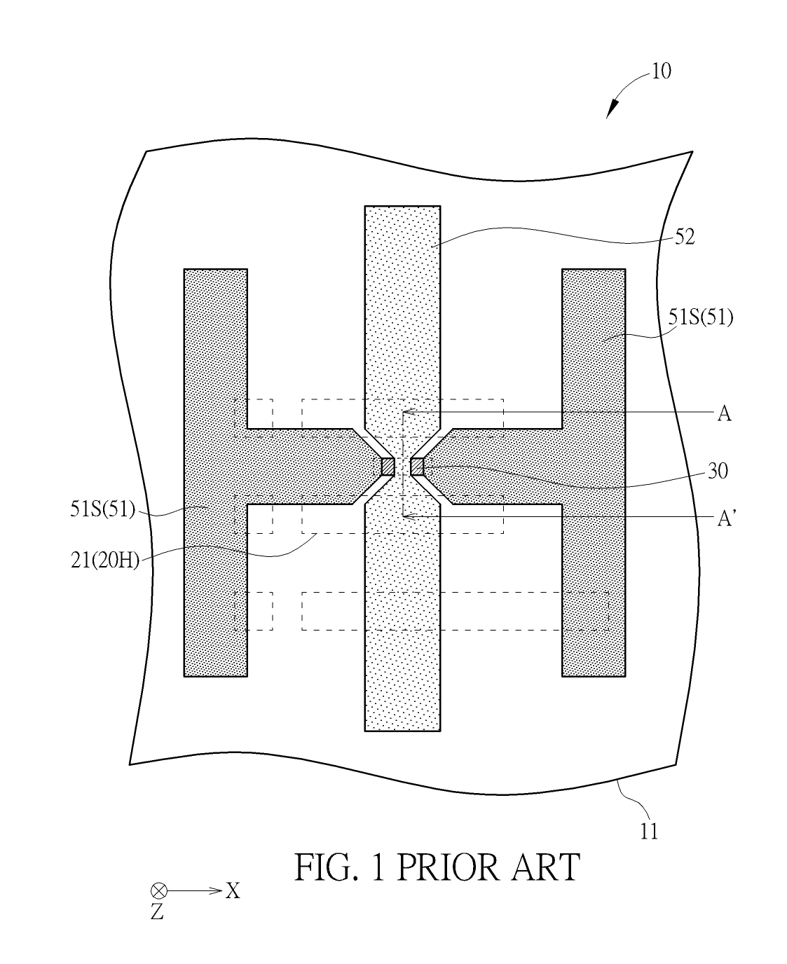

FIG. 2 is a schematic cross-sectional diagram taken along a line A-A′ in FIG. 1.

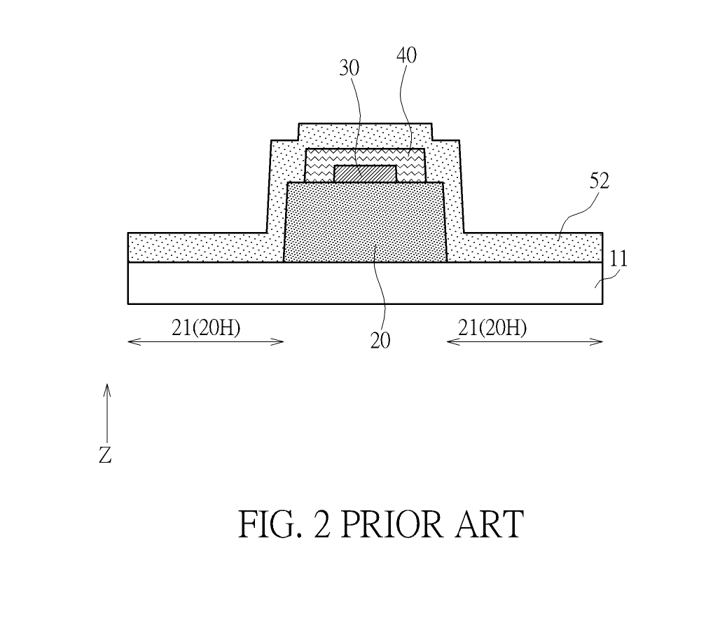

FIG. 3 is a schematic diagram illustrating a condition that a position of a light-shielding layer in FIG. 2 is shifted.

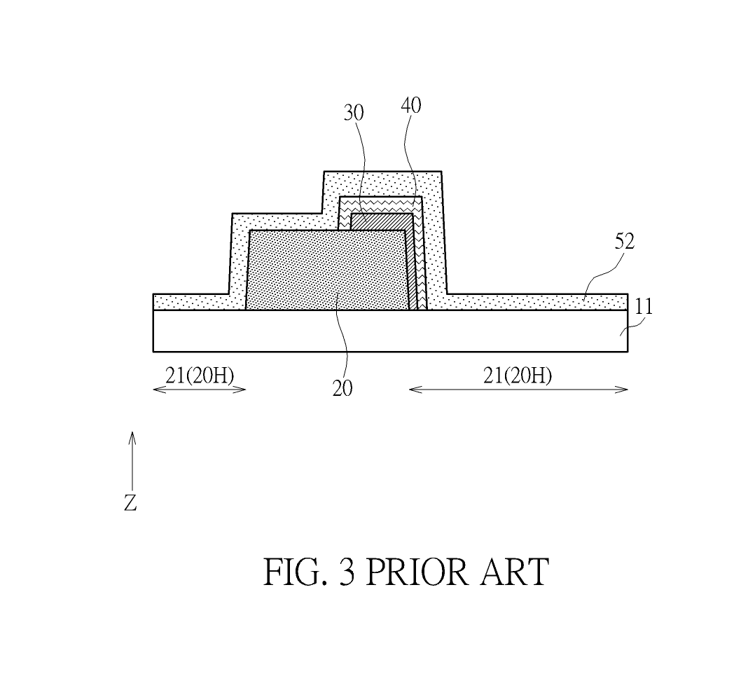

FIG. 4 is a schematic diagram illustrating another traditional crossed sensing unit of a touch panel.

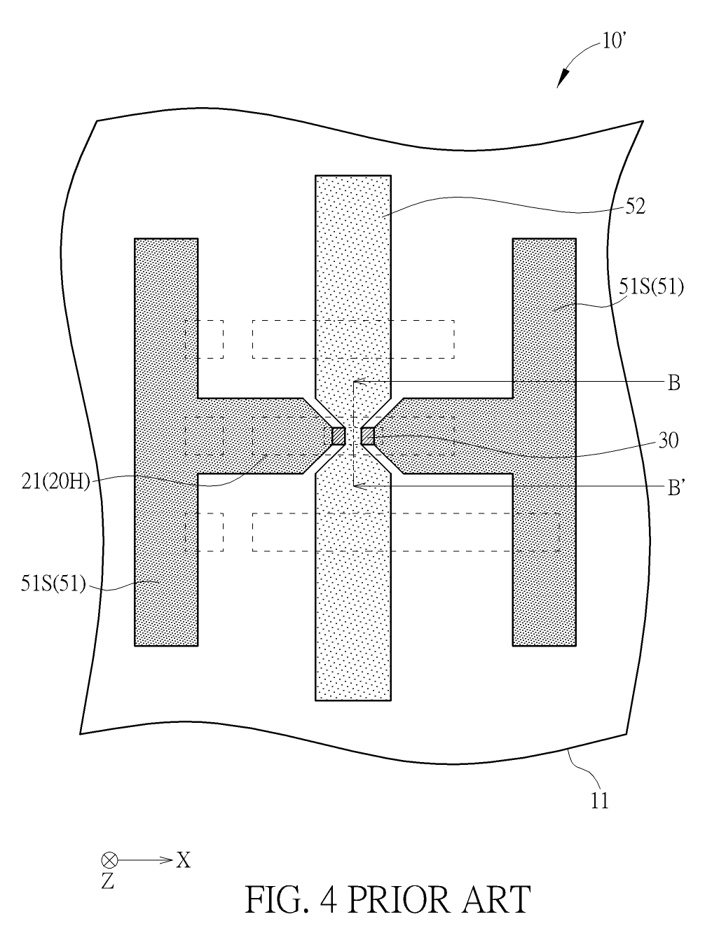

FIG. 5 is a schematic cross-sectional diagram taken along a line B-B′ in FIG. 4.

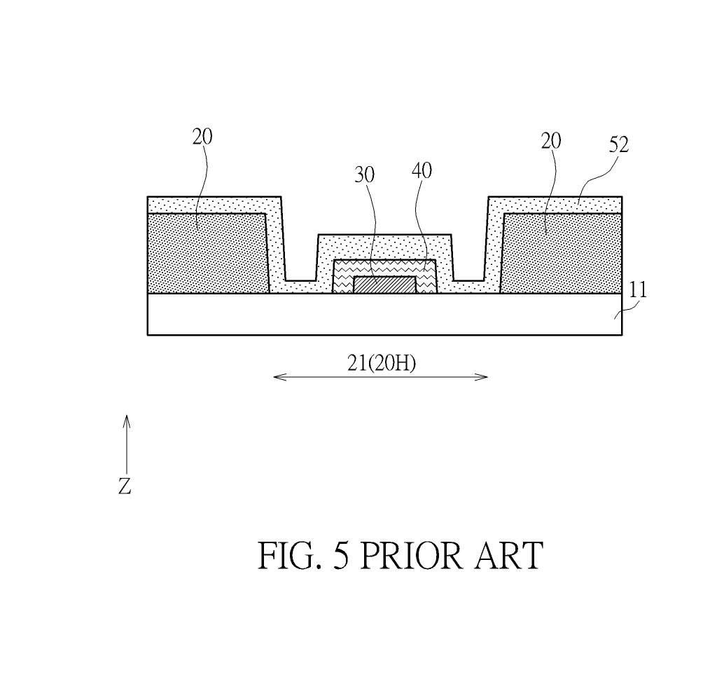

FIG. 6 is a schematic diagram illustrating a touch panel according to a preferred embodiment of the present invention.

FIG. 7 is a schematic diagram illustrating a crossed sensing unit of a touch panel according to a preferred embodiment of the present invention.

FIG. 8 is a schematic cross-sectional diagram taken along a line C-C′ in FIG. 7.

FIGS. 9-11 are schematic diagrams illustrating local parts of a first electrode and a second electrode in the touch panel according to the preferred embodiment of the present invention.

FIG. 12 is a schematic diagram illustrating a crossed sensing unit of a touch panel according to another preferred embodiment of the present invention.

FIG. 13 is a schematic cross-sectional diagram taken along a line D-D′ in FIG. 12.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

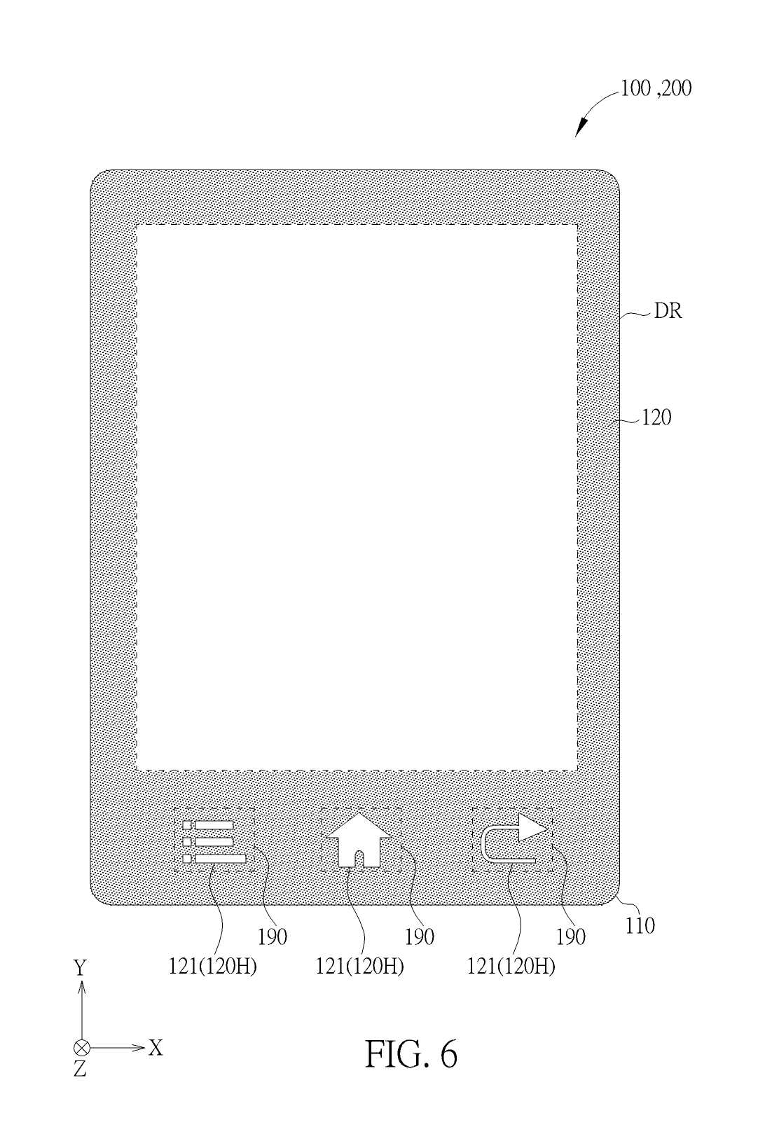

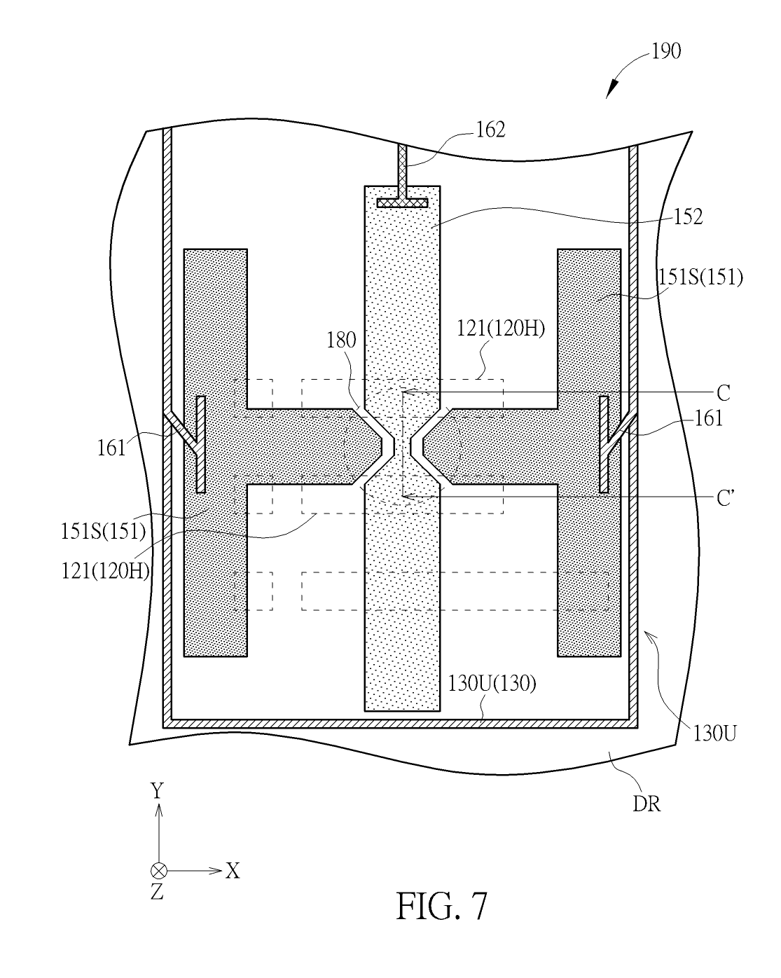

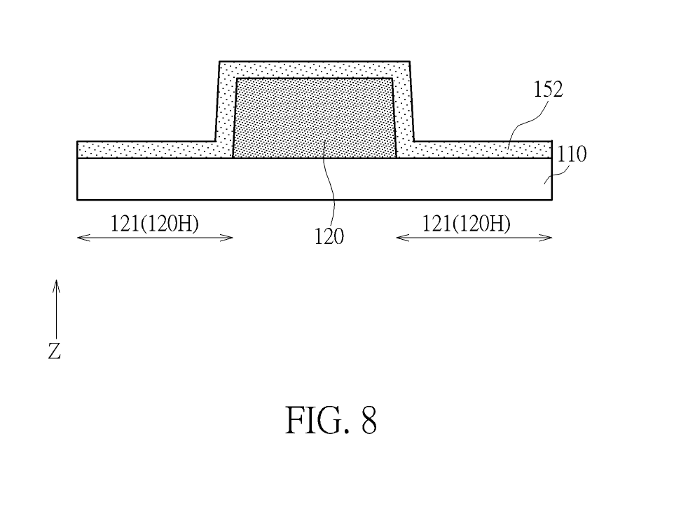

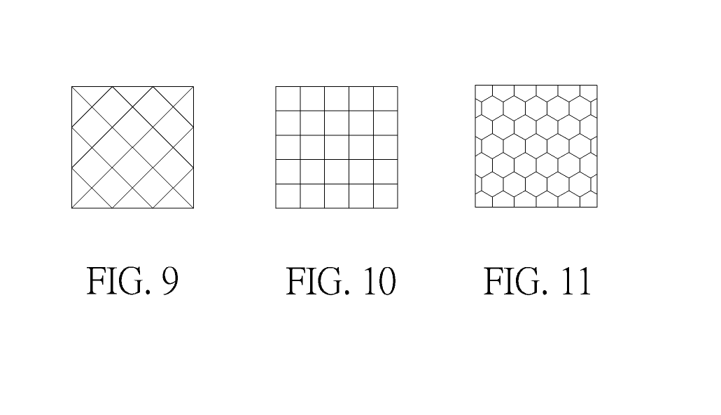

Please refer to FIGS. 6-11. FIG. 6 is a schematic diagram illustrating a touch panel according to a preferred embodiment of the present invention. FIG. 7 is a schematic diagram illustrating a crossed sensing unit of the touch panel in this embodiment. FIG. 8 is a schematic cross-sectional diagram taken along a line C-C′ in FIG. 7. FIGS. 9-11 are schematic diagrams illustrating local parts of a first electrode and a second electrode in the touch panel of this embodiment. As shown in FIGS. 6-8, a touch panel 100 is provided in this embodiment. The touch panel 100 includes a substrate 110 and a crossed sensing unit 190. The crossed sensing unit 190 is disposed on the substrate 110, and the crossed sensing unit 190 includes a first electrode 151, a second electrode 152, and a connecting line 130. The first electrode 151 includes two sub electrodes 151S disposed separately from each other and aligned along a first direction X. The second electrode 152 is disposed between the two sub electrodes 151S along the first direction X. The second electrode 152 preferably extends along a second direction Y, and the first direction X is substantially perpendicular to the second direction Y, but not limited thereto. The connecting line 130 is electrically connecting the two sub electrodes 151S, and the connecting line 130 does not overlap the second electrode 152 along a vertical projective direction Z perpendicular to the substrate 110. More specifically, the touch panel 100 may further include a first trace 161 and a second trace 162. The first trace 161 is electrically connected to the two sub electrodes 151S, and the second trace 162 is electrically connected to the second electrode 152. A first touch signal, such as a touch driving signal, may be transmitted to the two sub electrodes 151S, and a second touch signal, such as a touch sensing signal, received by the second electrode 152 may be transmitted to a control device (not shown) through the second trace 162 for touch point positioning. The above-mentioned touch sensing approach of the crossed sensing unit 190 may be regarded as a mutual capacitive type touch sensing approach, but not limited thereto. In addition, the touch panel 100 may further include a capacitive sensing region 180 disposed at a region where the second electrode 152 crosses the first electrode 151, and the connecting line 130 is not disposed in the capacitive sensing region 180. The capacitive sensing region 180 may be regarded as a region where a distance between the second electrode 152 and the two sub electrodes 151S is shortest so as to generate main capacitance for touch positioning. In other words, the crossed sensing unit 190 in the present invention does not have any traditional bridge connection structure, and the connecting line 130 is designed as a detour layout for electrically connecting the two sub electrodes 151S. The problems generated by the conventional bridge connection structure will be avoided accordingly. It is worth noting that the range of the capacitive sensing region 180 in this invention is not limited to the range shown in FIG. 7, and other regions between the sub electrode 151S and the second electrode 152 may also be regarded as the capacitive sensing region 180 as long as the sub electrode 151S and the second electrode 152 are close enough.

In this embodiment, the substrate 110 may include a rigid substrate, a flexible substrate, a protection substrate or other substrates made of appropriate materials. The rigid substrate may include a glass substrate and a ceramic substrate. The flexible substrate may include a plastic substrate, and the protection substrate may include a cover glass. The two sub electrodes 151S and the second electrode 152 may preferably include a transparent conductive pattern or metal mesh. For example, as shown in FIGS. 9-11, the metal mesh may include geometric patterns in identical or different shapes and sizes disposed in a stack configuration, such as rhombus in FIG. 9, square or rectangle in FIG. 10, and hexagon in FIG. 11. However, the metal mesh in the present invention is not limited to the shapes described in FIGS. 9-11, and metal mesh in other regular or irregular shapes may also be applied in the present invention. For example, sinusoidal metal mesh pattern may be used to form the two sub electrodes 151S and the second electrode 152 in the present invention. The connecting line 130 in this invention does not overlap the second electrode 152, and the connecting line 130 is connected to the first trace 161 at two ends of the two sub electrodes 151S so as to electrically connect the two sub electrodes 151S. The problems, such as electrostatic damages and stray capacitances, generated by the conventional bridge connection structure will be avoided accordingly, and the touch sensing effect and product reliability of the touch panel 100 may be enhanced too. It is worth noting that the connecting line 130 may also be an extension part extending from the two ends of the two sub electrodes 151S. In other words, the connecting line 130 may preferably include a metal conductive material, a transparent conductive material or other appropriate materials. The metal material mentioned above may include one of aluminum (Al), copper (Cu), silver (Ag), chromium (Cr), titanium (Ti), molybdenum (Mo), tantalum (Ta), a stack layer of the above-mentioned materials, or an alloy of the above-mentioned materials. The transparent conductive material mentioned above may include indium tin oxide (ITO), indium zinc oxide (IZO), aluminum zinc oxide (AZO), or other appropriate transparent conductive materials.

As shown in FIGS. 6-8, the touch panel 100 in this embodiment may further include a decoration region DR and at least one virtual key pattern 212. The decoration region is disposed on at least one side of the touch panel 100, and the crossed sensing unit 190 is disposed in the decoration region DR, but not limited thereto. In other words, the crossed sensing unit 190 may also be disposed in other regions of the touch panel 100 according to other design considerations. The virtual key pattern 121 is disposed in the decoration region DR, and the virtual key pattern 121 is disposed correspondingly to the crossed sensing unit 190. Therefore, the crossed sensing unit 190 may be used to detect whether the virtual key pattern 121 is touched or not, but not limited thereto. More specifically, the touch panel 100 in this embodiment may further include a light-shielding layer 120 disposed on the substrate 110 and in the decoration region DR. The light-shielding layer 120 may include at least one opening hole 120H, and the opening hole 120H is configured to form the virtual key pattern 121 described above. In other words, the virtual key pattern 121 may be composed of the opening hole 120H in the light-shielding layer 120. In other preferred embodiments of the present invention, a decoration layer (not shown) may be disposed in the opening hole 120H so as to form required color and texture effects of the virtual key pattern 121. The materials of the light-shielding layer 120 in this embodiment may include color resists, inks or other appropriate light-shielding materials. In this embodiment, even the virtual key pattern 121 is disposed correspondingly to the crossed sensing unit 190, and the position of the light-shielding layer 120 or the opening hole 120H directly corresponds to the capacitive sensing region 180, the forming process of the second electrode 152 will not be influenced and the second electrode 152 may not crack because the connecting line 130 is not disposed in the capacitive sensing region 180 where the second electrode 152 crosses the first electrode 151. The purpose of yield enhancement may be achieved accordingly. In addition, the connecting line 130 may preferably include a non-linear structure 130U at least partially surround the first electrode 151 and the second electrode 152. The connecting line 130 may have a short circuit effect for heavy current coming from outside because the charge accumulation is higher at the connecting line 130. For instance, as shown in FIG. 7, the non-linear structure 130U may be a U-shaped structure surrounding the lower half part of the first electrode 151 and the second electrode 152, but not limited thereto.

The following description will detail the different embodiments of the present invention. To simplify the description, identical components in each of the following embodiments are marked with identical symbols. For making it easier to understand the differences between the embodiments, the following description will detail the dissimilarities among different embodiments and the identical features will not be redundantly described.

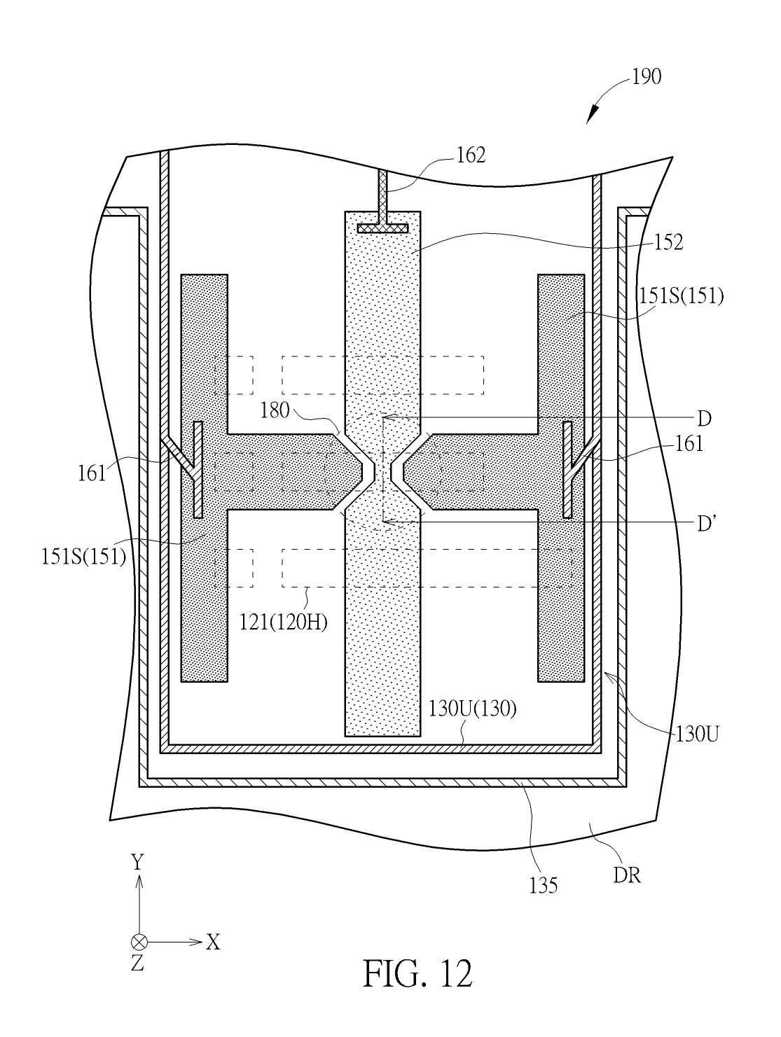

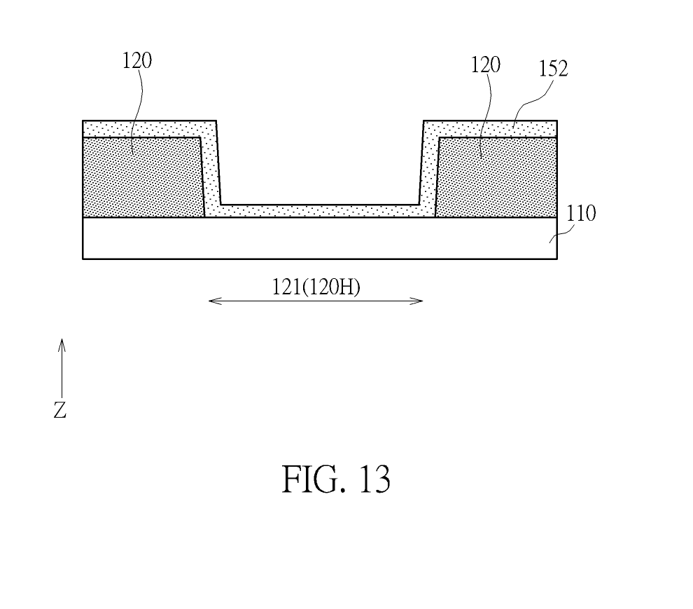

Please refer to FIG. 6, FIG. 12 and FIG. 13. FIG. 12 is a schematic diagram illustrating a crossed sensing unit of a touch panel according to another preferred embodiment of the present invention. FIG. 13 is a schematic cross-sectional diagram taken along a line D-D′ in FIG. 12. As shown in FIG. 6, FIG. 12 and FIG. 13, a touch panel 200 is provided in this embodiment. The difference between the touch panel 200 in this embodiment and the touch panel in the embodiment mentioned above is that, in this embodiment, the virtual key pattern 121 is disposed correspondingly to the crossed sensing unit 190, and a position of the opening hole 120H directly corresponds to a center of the capacitive sensing region 180. Because the connecting line 130 in this embodiment is not disposed in the capacitive sensing region 180, the forming process of the second electrode 152 will not be influenced by the traditional bridge connection structure. The purpose of yield enhancement may be achieved accordingly. The touch panel 200 in this embodiment may further include an outer trace 135 disposed in the decoration region DR. The non-linear structure 130U is disposed between the outer trace 135 and the first electrode 151, and the non-linear structure 130U is also disposed between the outer trace 135 and the second electrode 152 so as to keep the crossed sensing unit 190 from being influenced by the outer trace 135. The signal stability of the outer trace 135 may be improved accordingly.

To summarize the above descriptions, in the touch panel of the present invention, the crossed sensing unit is designed as a detour layout for electrically connecting the two sub electrodes separately disposed in the crossed sensing unit, and no traditional bridge connection structure is applied. The problems, such as electrostatic damages and stray capacitances, generated by the conventional bridge connection structure will be avoided accordingly, and the touch sensing effect and product reliability of the touch panel may be enhanced too. Additionally, when the crossed sensing unit in the present invention is disposed correspondingly to the virtual key pattern, the crack issue generated by the traditional bridge connection structure may be improved because the connecting line electrically connecting the two sub electrodes is not disposed in the capacitive sensing region, and the manufacturing yield may be enhanced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate; and
a crossed sensing unit, disposed on the substrate, the crossed sensing unit comprising:
a first electrode, the first electrode comprising two sub electrodes disposed separately from each other and aligned along a first direction;
a second electrode, disposed between the two sub electrodes; and
a connecting line, electrically connecting the two sub electrodes, wherein the connecting line does not overlap the second electrode along a vertical projective direction perpendicular to the substrate.

2. The touch panel of claim 1, further comprising a capacitive sensing region disposed at a region where the second electrode crosses the first electrode, wherein the connecting line is not disposed in the capacitive sensing region.

3. The touch panel of claim 1, further comprising:
a decoration region, disposed on at least one side of the touch panel, wherein the crossed sensing unit is disposed in the decoration region; and
a virtual key pattern, disposed in the decoration, wherein the virtual key pattern is disposed correspondingly to the crossed sensing unit.

4. The touch panel of claim 3, wherein the connecting line comprises a non-linear structure at least partially surround the first electrode and the second electrode.

5. The touch panel of claim 4, further comprising an outer trace disposed in the decoration region, wherein the non-linear structure is disposed between the outer trace and the first electrode.

6. The touch panel of claim 4, wherein the non-linear structure comprises a U-shaped structure.

7. The touch panel of claim 1, wherein the connecting line comprises a metal conductive material or a transparent conductive material.

8. The touch panel of claim 1, wherein the two sub electrodes and the second electrode comprise a transparent conductive pattern or metal mesh.

9. The touch panel of claim 3, further comprising a light-shielding layer disposed in the decoration region, wherein the light-shielding layer comprises at least one opening hole, and the opening hole is configured to form the virtual key pattern.
